(19) United States
(12) Patent Application Publication
(10) Pub. No.: US 2023/0288912 A1
(43) Pub. Date: Sep. 14, 2023

(54) WORKSTATION WITH DYNAMIC MACHINE VISION SENSING AND AUGMENTED REALITY

(71) Applicant: FARO Technologies, Inc., Lake Mary, FL (US)

(72) Inventors: Georgios Balatzis, Fellbach (DE); Michael Müller, Stuttgart (DE)

(21) Appl. No.: 18/075,560

(22) Filed: Dec. 6, 2022

Related U.S. Application Data
(60) Provisional application No. 63/285,124, filed on Dec. 2, 2021.

(51) Int. Cl. G05B 19/4099; B23P 19/04

(52) U.S. Cl. CPC G05B 19/4099; B23P 19/04; G05B 2219/49023

(57) ABSTRACT

A computer-implemented method includes identifying, by a controller, a part that is being transported to a workstation. The method further includes capturing a 3D scan of the part using a dynamic machine vision sensor. The method further includes validating the part by comparing the 3D scan of the part with a 3D model of the part. The method further includes, based on a determination that the part is valid, projecting a hologram that includes a sequence of assembly steps associated with the part. The method further includes, upon completion of the sequence of assembly steps, capturing a 3D scan of an item that is assembled using the part. The method further includes validating the item by comparing the 3D scan of the item with a 3D model of the item. The method further includes notifying a validity of the item.

### CROSS-REFERENCE TO RELATED APPLICATIONS

This application claims the benefit to U.S. Provisional Patent Application No. 63/285,124, filed Dec. 2, 2021, the contents of which are incorporated by reference herein in their entirety.

### BACKGROUND

The subject matter disclosed herein relates to a triangulation scanner. The triangulation scanner projects uncoded spots onto an object and, in response, determines three-dimensional (3D) coordinates of points on the object. The subject matter further relates to a workstation that facilitates dynamic machine vision sensing and augmented reality using triangulation scanning.

Triangulation scanners generally include at least one projector and at least two cameras, the projector, and camera separated by a baseline distance. Such scanners use a triangulation calculation to determine the 3D coordinates of points on an object-based at least in part on the projected pattern of light and the captured camera image. One category of triangulation scanner, referred to herein as a single-shot scanner, obtains 3D coordinates of the object points based on a single projected pattern of light. Another category of triangulation scanner, referred to herein as a sequential scanner, obtains 3D coordinates of the object points based on a sequence of projected patterns from a stationary projector onto the object.

In the case of a single-shot or single-image triangulation scanner, the triangulation calculation is based at least in part on a determined correspondence among elements in each of two patterns. The two patterns may include a pattern projected by the projector and a pattern captured by the camera. Alternatively, the two patterns may include a first pattern captured by a first camera and a second pattern captured by a second camera. In either case, the determination of 3D coordinates by the triangulation calculation provides that a correspondence be determined between pattern elements in each of the two patterns. In most cases, the correspondence is obtained by matching pattern elements in the projected or captured pattern. An alternative approach is described in U.S. Pat. No. 9,599,455 ('455) to Heidemann, et al., the contents of which are incorporated by reference herein. In this approach, the correspondence is determined, not by matching pattern elements, but by identifying spots (e.g., points or circles of light) at the intersection of epipolar lines from two cameras and a projector or from two projectors and a camera. In an aspect, supplementary 2D camera images may further be used to register multiple collected point clouds together in a common frame of reference. For the system described in Patent '455, the three camera and projector elements are arranged in a triangle, which enables the intersection of the epipolar lines.

Accordingly, while triangulation scanners are suitable for their intended purposes the need for improvement remains, particularly in providing a scanner having at least some of the features described herein.

### BRIEF DESCRIPTION

According to one or more embodiments, a computer-implemented method includes identifying, by a controller, a part that is being transported to a workstation. The method further includes capturing, by the controller, a 3D scan of the part using a dynamic machine vision sensor. The method further includes validating, by the controller, the part by comparing the 3D scan of the part with a 3D model of the part. The method further includes, based on a determination that the part is valid, projecting, by the controller, a hologram that includes a sequence of assembly steps associated with the part. The method further includes, upon completion of the sequence of assembly steps, capturing, by the controller, a 3D scan of an item that is assembled using the part. The method further includes validating, by the controller, the item by comparing the 3D scan of the item with a 3D model of the item. The method further includes notifying, by the controller, a validity of the item.

In one or more embodiments, the part is identified based on one of a machine-readable code associated with the part, and image recognition.

In one or more embodiments, comparing the 3D scan of the part with a 3D model of the part further includes determining an expected measurement of a portion of the part from the 3D model of the part, determining an actual measurement of the portion of the part from the 3D scan of the part, and comparing the expected measurement and the actual measurement.

In one or more embodiments, the hologram that that includes the sequence of assembly steps is a 3D hologram projected to overlap the part.

In one or more embodiments, the hologram that that includes the sequence of assembly steps is projected onto a designated portion of the workstation.

In one or more embodiments, the hologram that that includes the sequence of assembly steps further includes the 3D model with one or more highlighted portions that are to be worked upon.

In one or more embodiments, validating the item comprises displaying the 3D model of the item via an augmented reality device, with one or more portions highlighted, wherein the one or more highlighted portions identify portions of the item that fail to satisfy one or more specifications of the item.

In one or more embodiments, the method further includes initiating a transportation path to transport the item to a subsequent workstation in response to the item being deemed to be valid.

In one or more embodiments, the method further includes monitoring, by the controller, personal protective equipment at the workstation, and in response to the personal protective equipment not being equipped, pausing the hologram.

According to one or more embodiments, a system includes one or more dynamic machine vision sensors, an augmented reality device, and a controller coupled with the one or more dynamic machine vision sensors and the augmented reality device. The controller performs a method that includes identifying a part that is being transported to a workstation. The method further includes capturing a 3D scan of the part using the one or more dynamic machine vision sensors. The method further includes validating the part by comparing the 3D scan of the part with a 3D model of the part. The method further includes, based on a determination that the part is valid, projecting a hologram that includes a sequence of assembly steps associated with the part using the augmented reality device. The method further includes, upon completion of the sequence of assembly steps, capturing a 3D scan of an item that is assembled using the part. The method further includes validating the item by comparing the 3D scan of the item with a 3D model of the item. The method further includes notifying a validity of the item.

In one or more embodiments, comparing the 3D scan of the part with a 3D model of the part further includes determining an expected measurement of a portion of the part from the 3D model of the part, determining an actual measurement of the portion of the part from the 3D scan of the part, and comparing the expected measurement and the actual measurement.

In one or more embodiments, the hologram that that includes the sequence of assembly steps further includes the 3D model with one or more highlighted portions that are to be worked upon.

In one or more embodiments, validating the item comprises displaying the 3D model of the item via the augmented reality device, with one or more portions highlighted, wherein the one or more highlighted portions identify portions of the item that fail to satisfy one or more specifications of the item.

In one or more embodiments, the method further comprises, initiating a transportation path to transport the item to a subsequent workstation in response to the item being deemed to be valid.

In one or more embodiments, the method further comprises, monitoring, by the controller, personal protective equipment at the workstation, and in response to the personal protective equipment not being equipped, pausing the hologram.

According to one or more embodiments, a computer program product includes a non-transitory computer readable storage medium having computer executable instructions stored thereupon, the computer executable instructions when executed by one or more processors cause the one or more processors to perform a method. The method includes identifying a part that is being transported to a workstation. The method further includes capturing a 3D scan of the part using a dynamic machine vision sensor. The method further includes validating the part by comparing the 3D scan of the part with a 3D model of the part. The method further includes, based on a determination that the part is valid, projecting a hologram that includes a sequence of assembly steps associated with the part. The method further includes, upon completion of the sequence of assembly steps, capturing a 3D scan of an item that is assembled using the part. The method further includes validating the item by comparing the 3D scan of the item with a 3D model of the item. The method further includes notifying a validity of the item.

In one or more embodiments, the hologram that that includes the sequence of assembly steps further includes the 3D model with one or more highlighted portions that are to be worked upon.

In one or more embodiments, validating the item comprises displaying the 3D model of the item via an augmented reality device, with one or more portions highlighted, wherein the one or more highlighted portions identify portions of the item that fail to satisfy one or more specifications of the item.

In one or more embodiments, the method further includes initiating a transportation path to transport the item to a subsequent workstation in response to the item being deemed to be valid.

In one or more embodiments, the method further includes monitoring personal protective equipment at the workstation, and in response to the personal protective equipment not being equipped, pausing the hologram.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 depicts a workflow of a dynamic assembly and quality control workstation according to one or more aspects;

FIG. 2 depicts a flowchart of a method for a dynamic assembly and quality control at a workstation according to one or more aspects;

FIG. 3A depicts an example of a workstation according to one or more aspects;

FIG. 3B depicts another example of a workstation according to one or more aspects;

FIGS. 4A, 4B, 4C, 4D, 4E are isometric, partial isometric, partial top, partial front, and second partial top views, respectively, of a triangulation scanner according to an aspect of the present disclosure;

FIG. 5A is a schematic view of a triangulation scanner having a projector, a first camera, and a second camera according to an aspect of the present disclosure;

FIG. 5B is a schematic representation of a triangulation scanner having a projector that projects an uncoded pattern of uncoded spots, received by a first camera, and a second camera according to an aspect of the present disclosure;

FIG. 5C is an example of an uncoded pattern of uncoded spots according to an aspect of the present disclosure;

FIG. 5D is a representation of one mathematical method that might be used to determine a nearness of intersection of three lines according to an aspect of the present disclosure;

FIG. 5E is a list of elements in a method for determining 3D coordinates of an object according to an aspect of the present disclosure;

FIGS. 6A, 6B, 6C, 6D, 6E are schematic diagrams illustrating different types of projectors according to aspects of the present disclosure;

FIG. 7A illustrates a triangulation scanner used to measure an object moving on a conveyor belt according to an aspect of the present disclosure; and

FIG. 7B illustrates a triangulation scanner moved by a robot end effector, according to an aspect of the present disclosure.

The detailed description explains aspects of the disclosure, together with advantages and features, by way of example with reference to the drawings.

### DETAILED DESCRIPTION

“Industry 4.0” is a manufacturing or production philosophy that provides for capabilities that arise from connecting several different components in a factory, and ultimately allowing them to act by themselves, resulting in a computer automated manufacturing facility sometimes referred to as a “smart factory.” Measurement plays a vital role in the smart factory. If a manufactured part can be measured accurately, quickly and with fewer production stops, it can result in increased productivity. One of the purposes of Industry 4.0 is to provide greater repeatability coupled with higher flexibility—new, faster ways to measure components using scanning technology will help achieve this.

A technical challenge in a factory, such as a manufacturing facility, is that a lot of time is spent at workstations on manual assembly of parts during the manufacture of an item, e.g., automobiles, phones, computers, air conditioners, toys, or any other types of items. Typically, a quality control check is performed at another workstation after the assembly is completed. Frequently, the quality control check is performed by a user or sensor, different from a user or apparatus used to assemble the parts. The item is brought back into a manufacturing/assembly line after the quality control check in some cases. Routing the item in such a manner is time consuming and expensive, increasing the price and production time of the item. Further, such routing does not allow a manufacturing facility the flexibility of assembling items of different types at a particular workstation that is set up for assembling a particular item. Also, the same workstation, and same user (assigned to the workstation) cannot perform quality control of the item that was assembled at that workstation, because the quality control may require a different workstation (with different tools, etc.).

Technical solutions described herein address such inflexibilities in existing workplaces such as factories, manufacturing and/or assembly lines, etc. Further, technical solutions described herein improve the accuracy of measurements, and in turn, the quality of production of the item being manufactured.

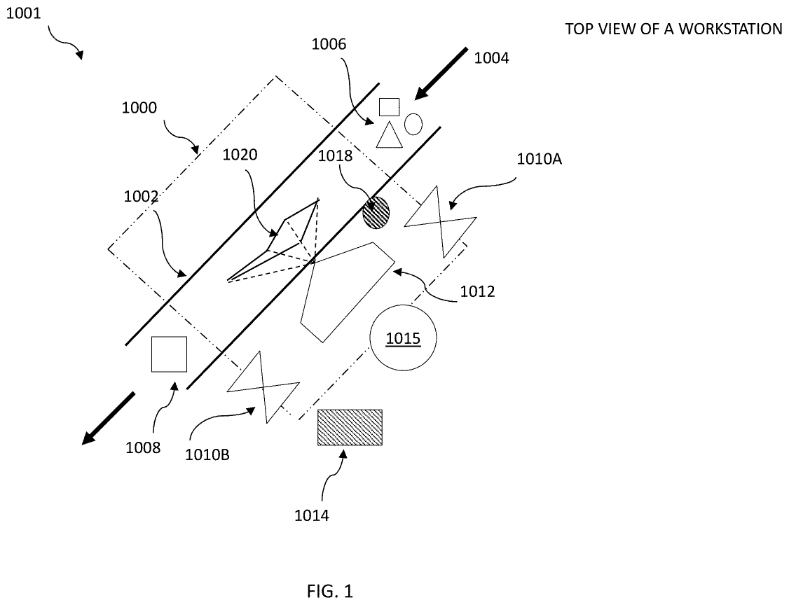

FIG. 1 depicts a workflow of a dynamic assembly and quality control workstation according to one or more aspects. User 1015 (e.g., responsible for assembly, manufacture, quality check, etc.) is stationed at a workstation 1000 in an assembly line 1001. Workstation 1000 is positioned on a transportation path 1002. Workstation 1000 is equipped with two dynamic machine vision sensors (DMVS) 1010A, 1010B, which are respectively located at an “entry” and an “exit” of workstation 1000. As will be described in more detail herein, the DMVS 1010A, 1010B allow for the optical (e.g. noncontact) measurement of items within the Workstation 1000. The entry and exit are based on a direction of flow 1004 of parts and items along the transportation path 1002. Parts 1006 that are to be assembled, manufactured, or quality checked, etc., “enter” workstation 1000. Further, in some aspects, an assembled item (or goods, widget, etc.) exits workstation 1000 after the assembly, manufacture, quality check, etc., is completed by user 1015.

In some aspects, the transportation path 1002 transports parts 1006 through a sequence of workstations 1000 placed one after the other. The transportation path 1002 can be a conveyor belt that transports parts 1006 to and from workstation 1000. Alternatively, the transportation path 1002 can include any other type of transportation mechanism, such as an autonomous robot, cart, etc.

User 1015, using workstation 1000, physically modifies the incoming parts 1006 to produce item 1008 that exits in some aspects. In other aspects, workstation 1000 modifies the part 1006 during a quality check that is performed, resulting in an updated item 1008, which is a modified version of the incoming parts 1006, and that exits workstation 1000.

Workstation 1000 is further equipped with augmented reality (AR) device 1012. Workstation 1000 is also equipped with a camera 1018. In some cases, the camera 1018 can be a camera subsystem that includes multiple cameras. In some cases, camera 1018 is integrated with the DMVS 1010A, 1010B.

A controller 1014 is coupled with the DMVS 1010A, 1010B, the AR device 1012, and the camera 1018. Controller 1014 may be local, i.e., at workstation 1000, in some aspects. In other aspects, controller 1014 is remotely located, for example, a central server, etc. Controller 1014 receives data, such as measurements, images, scans, etc., from workstation 1000, for example, from the DMVS 1010A, 1010B, and the camera 1018. Controller 1014 sends content to be output by the workstation, for example, by the AR device 1012. Controller 1014 can communicate with the devices in a wired and/or wireless manner in some aspects.

It is understood that the demarcation of workstation 1000 shown by the broken line is illustrative and that such a demarcation may or may not exist in some aspects and the claims should not be so limited. Further, the positions of the various components are also illustrative. For example, the AR device 1012 can be a fixed device coupled to a stand, a desk, a hook, or other such placeholders, in some aspects. In other aspects, the AR device 1012 can be a wearable device such as a headset, which user 1015 wears. In some other aspects, the AR device 1012 can be a portable computing device such as a phone, a tablet computer, etc., which can be dynamically moved by user 1015. Other components of FIG. 1 can also be positioned differently from what is shown.

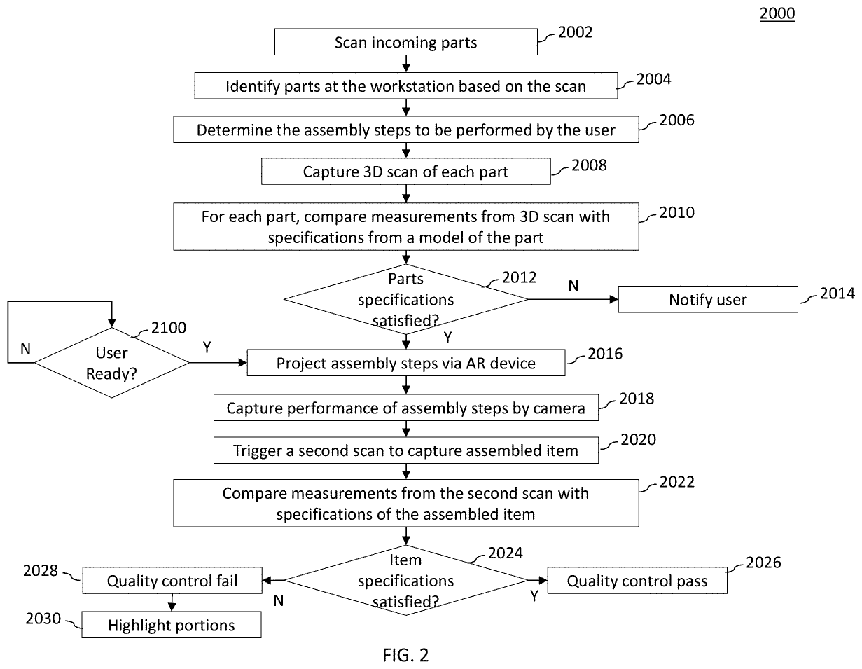

FIG. 2 depicts a flowchart of a method for dynamic assembly and quality control at a workstation according to one or more aspects. Workstation 1000 enables user 1015 to perform dynamic assembly and quality control by interacting with parts 1006 and item 1008 in an augmented reality space with precise measurements, as depicted by method 2000.

At block 2002, the DMVS 1010A at the entry of workstation 1000 scans incoming parts 1006. As used herein, the term “scan” means to optically measure the part 1006 to obtain three-dimensional (3D) coordinates of points on the surface of the part 1006. In some embodiments, the scanning of the part 1006 generates a collection or plurality of 3D coordinate points, sometimes referred to as a “point cloud.”

At 2004, based on the scan, controller 1014 identifies parts 1006. In some cases, the identification is based on image recognition/object detection techniques that are known or will be later developed. In some aspects, the parts are recognized using machine learning (e.g., convolutional neural networks, deep neural networks, etc.) and/or algorithms such as template matching, image segmentation, etc. Alternatively, or in addition, parts 1006 are identified by scanning a machine readable code (e.g., barcode, QR code, etc.) associated with each type of part 1006.

At 2006, controller 1014 determines one or more assembly steps to be performed using parts 1006. In some aspects, controller 1014 is pre-assigned the assembly steps to be performed based on a stage of manufacturing of the assembly line 1001. In other aspects, controller 1014 searches a database (not shown) to identify the assembly steps that are performed using the identified parts 1006. In yet other aspects, user 1015 indicates to controller 1014 the assembly steps that are to be performed.

At 2008, controller 1014 triggers capturing a 3D scan of each of parts 1006 using workstation 1000, for example, using the DMVS 1010A. The DMVS 1010A generates a 3D scan of each of the parts 1006. In one or more examples, user 1015 is instructed to place parts 1006 at predetermined positions/orientations on workstation 1000 for such a scan.

In some cases, controller 1014 causes the AR device 1012 to project a hologram 1020 (or any other AR view) at workstation 1000, where the hologram 1020 indicates a pose (i.e., position and orientation) to place each of parts 1006. The hologram 1020 can be projected in the 3D space of workstation 1000, for example, using a laser projector. Alternatively, or in addition, the hologram is projected onto a surface of workstation 1000, such as a desk. Once parts 1006 are placed as depicted in the hologram 1020, the DMVS 1010A captures the 3D scans.

At 2010, controller 1014 compares the captured 3D scans with predetermined models of each of parts 1006. The comparison is used for validating parts 1006. The predetermined models provide desired (expected) specifications of parts 1006. For example, the specifications can include dimensions, locations of landmarks (e.g., threading, holes, rivets, etc.), curvatures, etc. Controller 1014 can determine actual measurements of parts 1006 based on the captured 3D scans. Further, controller 1014 compares the actual measurements with the expected measurements from the specifications.

For example, the AR device 1012 projects a hologram 1020 on workstation 1000. In some aspects, user 2015 places the object (i.e., parts 1006 or item 1008) to match the projected hologram 1020. Alternatively, the AR device 1012 projects the hologram 1020 onto the object and dynamically adjusts the hologram 1020 to overlap parts 1006. The user 2015 can fine-tune the placement of parts 1006 based on the projected hologram 1020 to facilitate an accurate scan by the DMVS 1010A, in some aspects.

If a difference between a particular specification (e.g., dimension, curvature, etc.) of a part 1006 is not satisfied by the actual measurement of the part 1006 from the DMVS 1010A, user 1015 is notified, at blocks 2012, 2014. The specification is “not satisfied” if a difference between the specification and corresponding actual measurement exceeds or is below a predetermined threshold. The notification can be provided via the AR device 1012, for example, via the hologram 1020. User 1015, based on the notification, requests a different set of parts 1006. Alternatively, or in addition, the user 2015 can skip parts 1006 away from the transportation path 1002.

If parts 1006 satisfy the specifications, at blocks 2012, 2016, controller 1014 causes the AR device 1012 to display a hologram 1020. The hologram 1020 provides assembly steps in a specific order. In some aspects, the hologram 1020 includes an animation, e.g., a mesh, that displays portions of parts 1006 where the assembly steps are to be performed. For example, the assembly steps can identify specific portions of the parts that are to be coupled, e.g., using connectors like screws, nails, rivets, etc., or using steps like soldering, welding, etc. The hologram 1020 can also identify the exact position on parts 1006 where the assembly steps are to be performed.

In some aspects, the projected hologram 1020 overlaps parts 1006 that user 1015 is interacting with. For example, the hologram 1020 covers parts 1006. Based on one or more measurements from the DMVS 1010A, B, the exact position of parts 1006 and of the AR device 1012 in the 3D space of workstation 1000 are known. Accordingly, based on the positional information, controller 1014 can generate the hologram 1020 to identify the portions of parts 1006 where the step(s) is(are) to be performed in the 3D space.

In some aspects, the hologram 1020 is projected in a designated space on workstation 1000. User 1015, based on the information such as an animation, a description, etc., performs the steps on parts 1006.

In some aspects, before displaying the hologram 1020, controller 1014 confirms that user 1015 is ready to work on parts 1006, at block 2100. In one or more aspects, controller 1014 performs this check by detecting the presence of user 1015 at workstation 1000. In some aspects, the presence is detected using camera 1018. For example, using image/video analysis, controller 1014 analyzes an image/video captured by camera 1018 to detect if user 1015 is present at workstation 1000. In some aspects, controller 1014 can use face recognition to identify that user 1015, who is assigned to workstation 1000, is the person at workstation 1000. For example, machine learning (e.g., artificial neural networks, convolutional neural networks, etc.) or other types of algorithms (e.g., principal component analysis, etc.) can be used for face recognition.

In some aspects, in addition, controller 1014 checks that user 1015 is equipped with the appropriate personal protective equipment (PPE) before starting to work on the assembly. Controller 1014 performs the check by analyzing the image(s) (or video) from camera 1018. The PPE can include a helmet, safety glasses, etc. Controller 1014 uses machine learning (e.g., artificial neural networks, convolutional neural networks, etc.) to identify the PPE in the image from camera 1018. If the PPE is not detected, controller 1014 displays a warning via the AR device 1012. The warning notifies user 1015 to wear the PPE to receive further assistance from the workstation. Once the PPE is detected, controller 1014 continues to provide assistance via workstation 1000, such as via the AR device 1012. It is understood that such a PPE check can be performed prior to any other operations in the method 2000. In this way, controller 1014 checks for PPE at workstation 1000, and in response to the PPE not being equipped, pauses the hologram 1020, and other assistance is provided by workstation 1000. Pausing the hologram 1020 can include stopping the projection/display of the hologram 1020, and instead displaying a warning notifying user 1015 to equip the PPE.

In some aspects, at block 2018, the camera 1018 captures the performance of the one or more assembly steps by user 1015. In some aspects, controller 1014 recognizes the steps being performed and updates the hologram 1020 accordingly, for example, to display information pertaining to an assembly step being performed by user 1015. In some aspects, user 1015 indicates when s/he completes an assembly step so that controller 1014 can have information for the subsequent step displayed via the AR device 1012. The AR device 1012 can facilitate user 1015 to provide such notification, for example, using an interface such as a button, a wheel, a touch-surface, voice-enabled input, etc.

Once the assembly/manufacturing is completed, controller 1014 triggers a second 3D scan via the DMVS 1010B to capture the assembled item 1008, at block 2020.

At block 2022, the second 3D scan is compared with a 3D model that provides specifications of the assembled item 1008. The comparison is performed to validate item 1008. The 3D model of the assembled part can be a computer aided design (CAD) or any other such digital model of the assembled part. The comparison checks if one or more actual measurements that are determined from the captured 3D scan match corresponding measurements from the 3D model.

In one or more aspects, as part of the comparison, the 3D model of the assembled part is projected as a hologram 1020 onto workstation 1000. In some aspects, the hologram 1020 is projected to overlap the assembled part 1008. Alternatively, the hologram 1020 is projected in a designated area on workstation 1000. User 1015 places the assembled part 1008 to overlap the hologram 1020, in some cases.

If the specifications of the assembled item 1008 are satisfied, item 1008 is deemed to pass quality control, at blocks 2024, 2026. A specification is deemed to be “satisfied” if the actual measurement from the scan and the corresponding expected/desired measurement from the 3D model is within a predetermined threshold of each other (e.g., 0.1 micrometers, 1 micrometer, etc.). In one or more aspects, if the assembled item 1008 is deemed to pass quality control, the transportation path 1002 can be initiated to facilitate transporting the assembled item 1008 to the next workstation (1000) for further work.

Alternatively, if the specifications of the assembled item 1008 are not satisfied, item 1008 is deemed to fail quality control, at blocks 2024, 2028. It should be noted that the specifications of the assembled item 1008 can include multiple measurements. In one or more aspects, if at least one of the measurements are not satisfied, the specifications are deemed to be not satisfied. In other words, the specifications are deemed to be satisfied if all of the measurements are satisfied.

In some aspects, user 1015 is notified of a validity status of item 1008. The validity status can be indicated via the AR device 1012. In some aspects, in the case where the specifications are not satisfied, the portions of the assembled part that do not satisfy the corresponding measurements are highlighted in the projected hologram 1020 of the 3D model, at block 2030. In some aspects, the hologram 1020 is projected on the assembled item 1008, and accordingly, the highlighted portions in the hologram 1020 identify the parts of item 1008 that have to be inspected and further worked upon by user 1015.

In cases where the hologram 1020 is not projected onto item 1008, an image of item 1008 is captured by camera 1018, and the 3D model of item 1008 is projected on the captured image. The 3D model is projected in a translucent manner. Accordingly, the portions of item 1008 that do not satisfy the specifications can be identified in the captured image by highlighting the portions in the 3D model.

Highlighting the portions of item 1008 can include using a different color such as red, green, yellow, etc. Alternatively, or in addition, the highlighting can be performed using any other visual attribute such as borders, shading. Alternatively, or in addition, the highlighting can be performed using one or more annotations, including but not limited to text, icons, shapes, animations, etc.

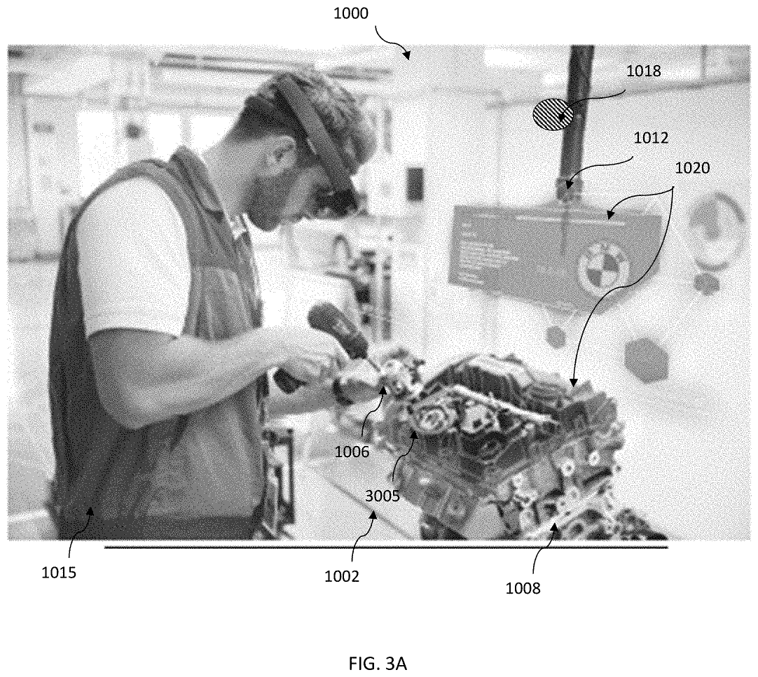

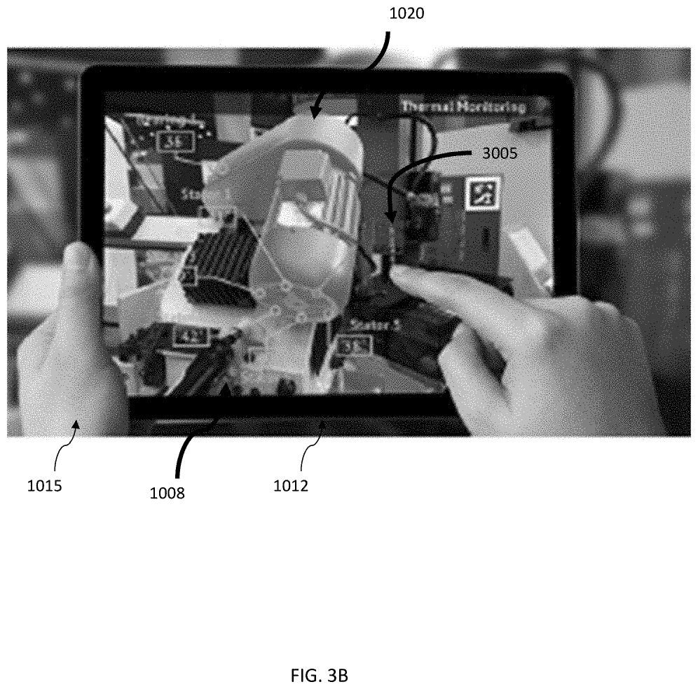

FIG. 3A depicts an example of a workstation 1000. The hologram 1020, in this case, is a 3D hologram projected onto the assembled item 1008 and/or parts 1006. The hologram 1020 can include separate portions. For example, a first portion includes the 3D model that is projected onto parts 1006 and/or item 1008; and a second portion that includes description/annotations about the steps to be performed. The hologram 1020 further includes highlighted portion 3005. The highlighted portion identifies a portion that user 1015 has to operate on to assemble the part 1006, for example. The highlighted portion 3005 can be identified for other reasons in other aspects.

FIG. 3B depicts another example of a workstation 1000. The hologram 1020, in this case, is a 2D hologram displayed on an AR device 1012, such as a tablet computer. The highlighted portion 3005, in this case, shows a portion that does not satisfy a specification.

It is understood that other examples of the workstation are possible in other aspects and that FIG. 3A and FIG. 3B are not to be construed as limiting examples of the technical solutions described herein.

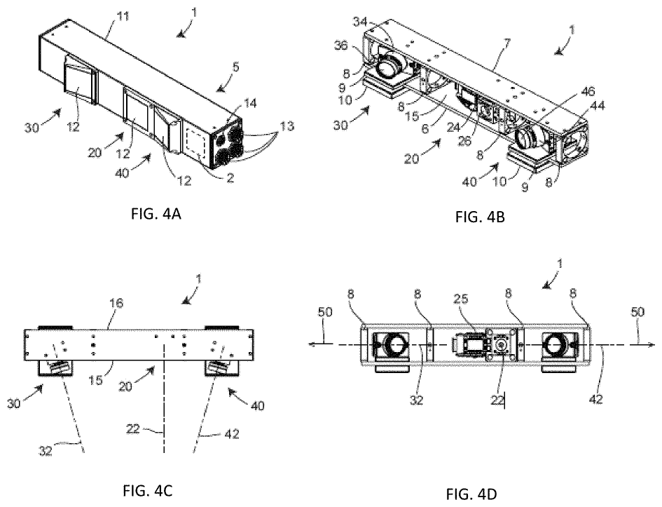

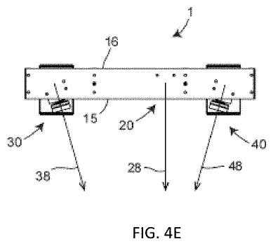

Illustrated in FIGS. 4A, 4B, 4C, 4D, is a 3D coordinate measurement device, such as triangulation scanner 1, which includes a body 5, a projector 20, a first camera 30, and a second camera 40. It should be appreciated that while embodiments herein refer to a triangulation scanner, this is for example purposes and the claims should not be so limited. In other embodiments, other types of 3D coordinate measurement devices may be used, such as but not limited to a time-of-flight scanner, a structured light scanner, and unstructured light scanner, a laser line probe, a line scanner, a flying-dot scanner, a depth camera, a photogrammetry device, or a combination of the foregoing for example.

In an aspect, the projector optical axis 22 of the projector 20, the first-camera optical axis 32 of the first camera 30, and the second-camera optical axis 42 of the second camera 40 all lie on a common plane 50, as shown in FIGS. 4C, 4D. In some aspects, an optical axis passes through a center of symmetry of an optical system, which might be a projector or a camera, for example. For example, an optical axis may pass through a center of curvature of lens surfaces or mirror surfaces in an optical system. The common plane 50, also referred to as a first plane 50, extends perpendicular into and out of the paper in FIG. 4D.

In an aspect, the body 5 includes a bottom support structure 6, a top support structure 7, spacers 8, camera mounting plates 9, bottom mounts 10, dress cover 11, windows 12 for the projector and cameras, Ethernet connectors 13, and GPIO connector 14. In addition, the body includes a front side 15 and a back side 16. In an aspect, the bottom support structure 6 and the top support structure 7 are flat plates made of carbon-fiber composite material. In an aspect, the carbon-fiber composite material has a low coefficient of thermal expansion (CTE). In an aspect, the spacers 8 are made of aluminum and are sized to provide a common separation between the bottom support structure 6 and the top support structure 7.

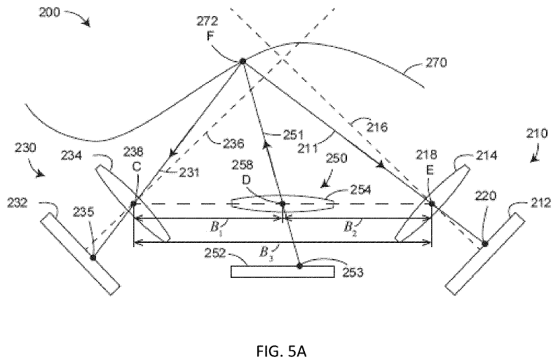

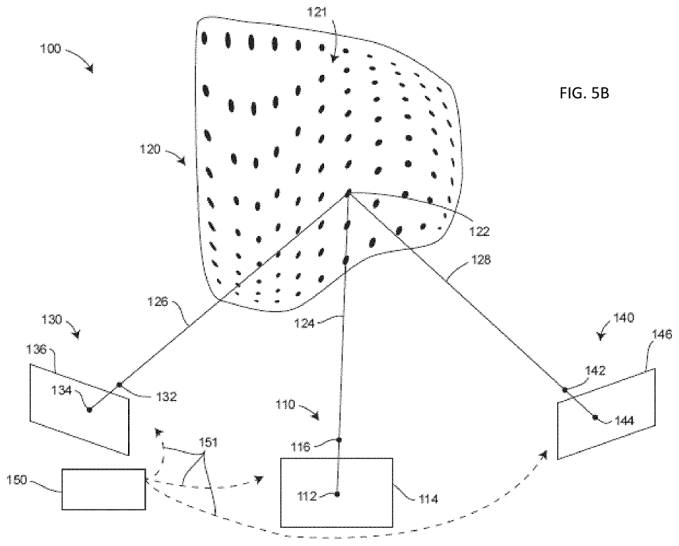

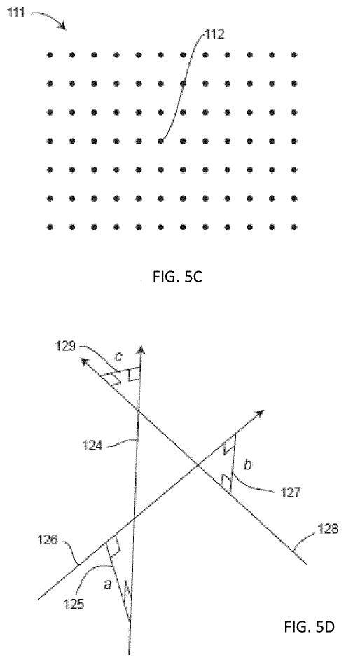

In an aspect, the projector 20 includes a projector body 24 and a projector front surface 26. In an aspect, the projector 20 includes a light source 25 that attaches to the projector body 24 that includes a turning mirror and a DOE, as explained herein below with respect to FIGS. 5A, 5B, 5C. The light source 25 may be a laser, a superluminescent diode, or a partially coherent LED, for example. In an aspect, the DOE produces an array of spots arranged in a regular pattern. In an aspect, the projector 20 emits light at a near-infrared wavelength.

In an aspect, the first camera 30 includes a first-camera body 34 and a first-camera front surface 36. In an aspect, the first camera includes a lens, a photosensitive array, and camera electronics. The first camera 30 forms on the photosensitive array a first image of the uncoded spots projected onto an object by the projector 20. In an aspect, the first camera responds to near-infrared light.

In an aspect, the second camera 40 includes a second-camera body 44 and a second-camera front surface 46. In an aspect, the second camera includes a lens, a photosensitive array, and camera electronics. The second camera 40 forms a second image of the uncoded spots projected onto an object by the projector 20. In an aspect, the second camera responds to light in the near-infrared spectrum. In an aspect, a processor 2 is used to determine 3D coordinates of points on an object according to methods described herein below. The processor 2 may be included inside the body 5 or may be external to the body. In further aspects, more than one processor is used. In still further aspects, the processor 2 may be remotely located from the triangulation scanner.

FIG. 4E is a top view of the triangulation scanner 1. A projector ray 28 extends along the projector optical axis from the body of the projector 24 through the projector front surface 26. In doing so, the projector ray 28 passes through the front side 15. A first-camera ray 38 extends along the first-camera optical axis 32 from the body of the first camera 34 through the first-camera front surface 36. In doing so, the front-camera ray 38 passes through the front side 15. A second-camera ray 48 extends along the second-camera optical axis 42 from the body of the second camera 44 through the second-camera front surface 46. In doing so, the second-camera ray 48 passes through the front side 15.

FIGS. 5A-5D show elements of a triangulation scanner 200 that might, for example, be the triangulation scanner 1 shown in FIGS. 4A, 4B, 4C, 4D, 4E. In an aspect, the triangulation scanner 200 includes a projector 250, a first camera 210, and a second camera 230. In an aspect, the projector 250 creates a pattern of light on a pattern generator plane 252. An exemplary corrected point 253 on the pattern projects a ray of light 251 through the perspective center 258 (point D) of the lens 254 onto an object surface 270 at a point 272 (point F). The point 272 is imaged by the first camera 210 by receiving a ray of light from the point 272 through the perspective center 218 (point E) of the lens 214 onto the surface of a photosensitive array 212 of the camera as a corrected point 220. The point 220 is corrected in the read-out data by applying a correction value to remove the effects of lens aberrations. The point 272 is likewise imaged by the second camera 230 by receiving a ray of light from the point 272 through the perspective center 238 (point C) of the lens 234 onto the surface of the photosensitive array 232 of the second camera as a corrected point 235. It should be understood that as used herein any reference to a lens includes any type of lens system whether a single lens or multiple lens elements, including an aperture within the lens system. It should be understood that any reference to a projector in this document refers not only to a system projecting with a lens or lens system an image plane to an object plane. The projector does not necessarily have a physical pattern-generating plane 252 but may have any other set of elements that generate a pattern. For example, in a projector having a DOE, the diverging spots of light may be traced backward to obtain a perspective center for the projector and also to obtain a reference projector plane that appears to generate the pattern. In most cases, the projectors described herein propagate uncoded spots of light in an uncoded pattern. However, a projector may further be operable to project coded spots of light, to project in a coded pattern, or to project coded spots of light in a coded pattern. In other words, in some aspects of the present disclosure, the projector is at least operable to project uncoded spots in an uncoded pattern but may in addition project in other coded elements and coded patterns.

In an aspect where the triangulation scanner 200 of FIGS. 5A-5D is a single-shot scanner that determines 3D coordinates based on a single projection of a projection pattern and a single image captured by each of the two cameras, then a correspondence between the projector point 253, the image point 220, and the image point 235 may be obtained by matching a coded pattern projected by the projector 250 and received by the two cameras 210, 230. Alternatively, the coded pattern may be matched for two of the three elements-for example, the two cameras 210, 230 or for the projector 250 and one of the two cameras 210 or 230. This is possible in a single-shot triangulation scanner because of coding in the projected elements or in the projected pattern or both.

After a correspondence is determined among the projected elements, a triangulation calculation is performed to determine 3D coordinates of the projected element on an object. For FIGS. 5A-5D, the elements are uncoded spots projected in an uncoded pattern. In an aspect, a triangulation calculation is performed based on selection of a spot for which correspondence has been obtained on each of two cameras. In this aspect, the relative position and orientation of the two cameras is used. For example, the baseline distance B₃ between the perspective centers 218 and 238 is used to perform a triangulation calculation based on the first image of the first camera 210 and on the second image of the second camera 230. Likewise, the baseline B₁ is used to perform a triangulation calculation based on the projected pattern of the projector 250 and on the second image of the second camera 230. Similarly, the baseline B₂ is used to perform a triangulation calculation based on the projected pattern of the projector 250 and on the first image of the first camera 210. In an aspect of the present disclosure, the correspondence is determined based at least on an uncoded pattern of uncoded elements projected by the projector, a first image of the uncoded pattern captured by the first camera, and a second image of the uncoded pattern captured by the second camera. In an aspect, the correspondence is further based at least in part on a position of the projector, the first camera, and the second camera. In a further aspect, the correspondence is further based at least in part on an orientation of the projector, the first camera, and the second camera.

The term “uncoded element” or “uncoded spot” as used herein refers to a projected or imaged element that includes no internal structure that enables it to be distinguished from other uncoded elements that are projected or imaged. The term “uncoded pattern” as used herein refers to a pattern in which information is not encoded in the relative positions of projected or imaged elements. For example, one method for encoding information into a projected pattern is to project a quasi-random pattern of “dots.” Such a quasi-random pattern contains information that may be used to establish correspondence among points and hence is not an example of an uncoded pattern. An example of an uncoded pattern is a rectilinear pattern of projected pattern elements.

In an aspect, uncoded spots are projected in an uncoded pattern as illustrated in the scanner system 100 of FIG. 5B. In an aspect, the scanner system 100 includes a projector 110, a first camera 130, a second camera 140, and a processor 150. The projector projects an uncoded pattern of uncoded spots off a projector reference plane 114. In an aspect illustrated in FIGS. 5B and 2C, the uncoded pattern of uncoded spots is a rectilinear array 111 of circular spots that form illuminated object spots 121 on the object 120. In an aspect, the rectilinear array of spots 111 arriving at the object 120 is modified or distorted into the pattern of illuminated object spots 121 according to the characteristics of the object 120. An exemplary uncoded spot 112 from within the projected rectilinear array 111 is projected onto the object 120 as a spot 122. The direction from the projector spot 112 to the illuminated object spot 122 may be found by drawing a straight line 124 from the projector spot 112 on the reference plane 114 through the projector perspective center 116. The location of the projector perspective center 116 is determined by the characteristics of the projector optical system.

In an aspect, the illuminated object spot 122 produces a first image spot 134 on the first image plane 136 of the first camera 130. The direction from the first image spot to the illuminated object spot 122 may be found by drawing a straight line 126 from the first image spot 134 through the first camera perspective center 132. The location of the first camera perspective center 132 is determined by the characteristics of the first camera optical system.

In an aspect, the illuminated object spot 122 produces a second image spot 144 on the second image plane 146 of the second camera 140. The direction from the second image spot 144 to the illuminated object spot 122 may be found by drawing a straight line 126 from the second image spot 144 through the second camera perspective center 142. The location of the second camera perspective center 142 is determined by the characteristics of the second camera optical system.

In an aspect, a processor 150 is in communication with the projector 110, the first camera 130, and the second camera 140. Either wired or wireless channels 151 may be used to establish connection among the processor 150, the projector 110, the first camera 130, and the second camera 140. The processor may include a single processing unit or multiple processing units and may include components such as microprocessors, field programmable gate arrays (FPGAs), digital signal processors (DSPs), and other electrical components. The processor may be local to a scanner system that includes the projector, first camera, and second camera, or it may be distributed and may include networked processors. The term processor encompasses any type of computational electronics and may include memory storage elements.

FIG. 5E shows elements of a method 180 for determining 3D coordinates of points on an object. An element 182 includes projecting, with a projector, a first uncoded pattern of uncoded spots to form illuminated object spots on an object. FIGS. 5B, 5C illustrate this element 182 using an aspect 100 in which a projector 110 projects a first uncoded pattern of uncoded spots 111 to form illuminated object spots 121 on an object 120.

A method element 184 includes capturing with a first camera the illuminated object spots as first-image spots in a first image. This element is illustrated in FIG. 5B using an aspect in which a first camera 130 captures illuminated object spots 121, including the first-image spot 134, which is an image of the illuminated object spot 122. A method element 186 includes capturing with a second camera the illuminated object spots as second-image spots in a second image. This element is illustrated in FIG. 5B using an aspect in which a second camera 140 captures illuminated object spots 121, including the second-image spot 144, which is an image of the illuminated object spot 122.

A first aspect of method element 188 includes determining with a processor 3D coordinates of a first collection of points on the object based at least in part on the first uncoded pattern of uncoded spots, the first image, the second image, the relative positions of the projector, the first camera, and the second camera, and a selected plurality of intersection sets. This aspect of the element 188 is illustrated in FIGS. 5B, 5C using an aspect in which the processor 150 determines the 3D coordinates of a first collection of points corresponding to object spots 121 on the object 120 based at least in the first uncoded pattern of uncoded spots 111, the first image 136, the second image 146, the relative positions of the projector 110, the first camera 130, and the second camera 140, and a selected plurality of intersection sets. An example from FIG. 5B of an intersection set is the set that includes the points 112, 134, and 144. Any two of these three points may be used to perform a triangulation calculation to obtain 3D coordinates of the illuminated object spot 122 as discussed herein above in reference to FIGS. 5A, 5B.

A second aspect of the method element 188 includes selecting with the processor a plurality of intersection sets, each intersection set including a first spot, a second spot, and a third spot, the first spot being one of the uncoded spots in the projector reference plane, the second spot being one of the first-image spots, the third spot being one of the second-image spots, the selecting of each intersection set based at least in part on the nearness of intersection of a first line, a second line, and a third line, the first line being a line drawn from the first spot through the projector perspective center, the second line being a line drawn from the second spot through the first-camera perspective center, the third line being a line drawn from the third spot through the second-camera perspective center. This aspect of the element 188 is illustrated in FIG. 5B using an aspect in which one intersection set includes the first spot 112, the second spot 134, and the third spot 144. In this aspect, the first line is the line 124, the second line is the line 126, and the third line is the line 128. The first line 124 is drawn from the uncoded spot 112 in the projector reference plane 114 through the projector perspective center 116. The second line 126 is drawn from the first-image spot 134 through the first-camera perspective center 132. The third line 128 is drawn from the second-image spot 144 through the second-camera perspective center 142. The processor 150 selects intersection sets based at least in part on the nearness of intersection of the first line 124, the second line 126, and the third line 128.

The processor 150 may determine the nearness of intersection of the first line, the second line, and the third line based on any of a variety of criteria. For example, in an aspect, the criterion for the nearness of intersection is based on a distance between a first 3D point and a second 3D point. In an aspect, the first 3D point is found by performing a triangulation calculation using the first image point 134 and the second image point 144, with the baseline distance used in the triangulation calculation being the distance between the perspective centers 132 and 142. In the aspect, the second 3D point is found by performing a triangulation calculation using the first image point 134 and the projector point 112, with the baseline distance used in the triangulation calculation being the distance between the perspective centers 134 and 116. If the three lines 124, 126, and 128 nearly intersect at the object point 122, then the calculation of the distance between the first 3D point and the second 3D point will result in a relatively small distance. On the other hand, a relatively large distance between the first 3D point and the second 3D would indicate that the points 112, 134, and 144 did not all correspond to the object point 122.

As another example, in an aspect, the criterion for the nearness of the intersection is based on a maximum of closest-approach distances between each of the three pairs of lines. This situation is illustrated in FIG. 5D. A line of closest approach 125 is drawn between the lines 124 and 126. The line 125 is perpendicular to each of the lines 124, 126 and has a nearness-of-intersection length a. A line of closest approach 127 is drawn between the lines 126 and 128. The line 127 is perpendicular to each of the lines 126, 128 and has length b. A line of closest approach 129 is drawn between the lines 124 and 128. The line 129 is perpendicular to each of the lines 124, 128 and has length c. According to the criterion described in the aspect above, the value to be considered is the maximum of a, b, and c. A relatively small maximum value would indicate that points 112, 134, and 144 have been correctly selected as corresponding to the illuminated object point 122. A relatively large maximum value would indicate that points 112, 134, and 144 were incorrectly selected as corresponding to the illuminated object point 122.

The processor 150 may use many other criteria to establish the nearness of intersection. For example, for the case in which the three lines were coplanar, a circle inscribed in a triangle formed from the intersecting lines would be expected to have a relatively small radius if the three points 112, 134, 144 corresponded to the object point 122. For the case in which the three lines were not coplanar, a sphere having tangent points contacting the three lines would be expected to have a relatively small radius.

It should be noted that the selecting of intersection sets based at least in part on a nearness of intersection of the first line, the second line, and the third line is not used in most other projector-camera methods based on triangulation. For example, for the case in which the projected points are coded points, which is to say, recognizable as corresponding when compared on projection and image planes, there is no need to determine a nearness of intersection of the projected and imaged elements. Likewise, when a sequential method is used, such as the sequential projection of phase-shifted sinusoidal patterns, there is no need to determine the nearness of intersection as the correspondence among projected and imaged points is determined based on a pixel-by-pixel comparison of phase determined based on sequential readings of optical power projected by the projector and received by the camera(s). The method element 190 includes storing 3D coordinates of the first collection of points.

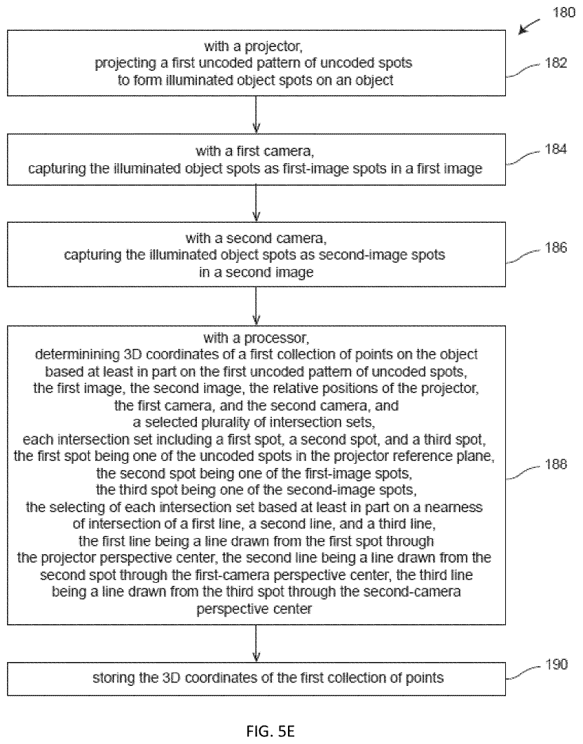

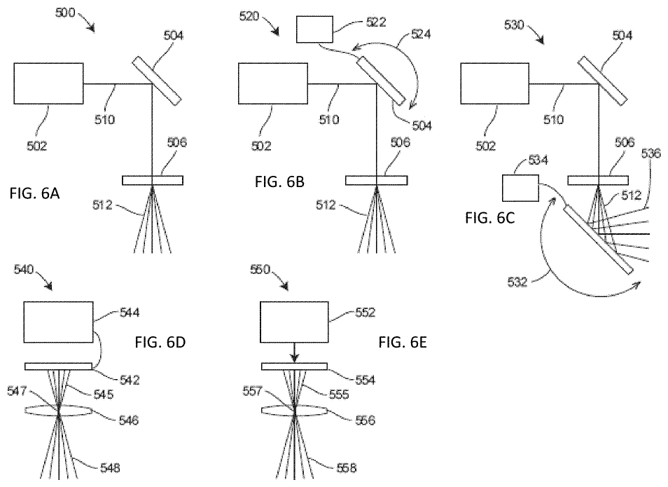

FIGS. 6A, 6B, 6C, 6D, 6E are schematic illustrations of alternative aspects of the projector 20. In some aspects, the projector 20 can be used as the AR 1012 to project the hologram(s) 1020. In FIG. 6A, a projector 500 includes a light source, mirror 504, and diffractive optical element (DOE) 506. The light source 502 may be a laser, a superluminescent diode, or a partially coherent LED, for example. The light source 502 emits a beam of light 510 that reflects off mirror 504 and passes through the DOE. In an aspect, the DOE 506 produces an array of diverging and uniformly distributed light spots 512. In FIG. 6B, a projector 520 includes the light source 502, mirror 504, and DOE 506 as in FIG. 6A. However, in system 520 of FIG. 6B, the mirror 504 is attached to an actuator 522 that causes rotation 524 or some other motion (such as translation) in the mirror. In response to the rotation 524, the reflected beam off the mirror 504 is redirected or steered to a new position before reaching the DOE 506 and producing the collection of light spots 512. In system 530 of FIG. 6C, the actuator is applied to a mirror 532 that redirects the beam 512 into a beam 536. Other types of steering mechanisms such as those that employ mechanical, optical, or electro-optical mechanisms may alternatively be employed in the systems of FIGS. 6A, 6B, 6C. In other aspects, the light passes first through the pattern generating element 506 and then through the mirror 504 or is directed towards the object space without a mirror 504.

In the system 540 of FIG. 6D, an electrical signal is provided by the electronics 544 to drive a projector pattern generator 542, which may be a pixel display such as a Liquid Crystal on Silicon (LCoS) display to serve as a pattern generator unit, for example. The light 545 from the LCoS display 542 is directed through the perspective center 547 from which it emerges as a diverging collection of uncoded spots 548. In system 550 of FIG. 6E, a source is light 552 may emit light that may be sent through or reflected off of a pattern generating unit 554. In an aspect, the source of light 552 sends light to a digital micromirror device (DMD), which reflects the light 555 through a lens 556. In an aspect, the light is directed through a perspective center 557 from which it emerges as a diverging collection of uncoded spots 558 in an uncoded pattern. In another aspect, the source of light 562 passes through a slide 554 having an uncoded pattern of dots before passing through a lens 556 and proceeding as an uncoded pattern of light 558. In another aspect, the light from the light source 552 passes through a lenslet array 554 before being redirected into the pattern 558. In this case, inclusion of the lens 556 is optional.

The actuators 522, 534, also referred to as beam steering mechanisms, may be any of several types such as a piezo actuator, a microelectromechanical system (MEMS) device, a magnetic coil, or a solid-state deflector.

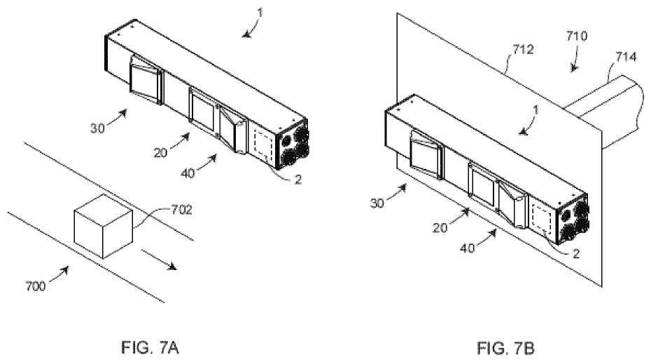

FIGS. 7A, 7B illustrate two different aspects for using the triangulation scanner 1 in an automated environment. FIG. 7A illustrates an aspect in which a scanner 1 is fixed in position and an object under test 702 is moved, such as on a conveyor belt 700 or other transport device (1002). The scanner 1 obtains 3D coordinates for the object 702. In an aspect, a processor, either internal or external to the scanner 1, further determines whether the object 702 meets its dimensional specifications. In some aspects, the scanner 1 is fixed in place, such as in a factory or factory cell for example, and used to monitor activities. In one aspect, the processor 2 monitors whether there is a probability of contact with humans from moving equipment in a factory environment and, in response, issue warnings, alarms, or cause equipment to stop moving.

FIG. 7B illustrates an aspect in which a triangulation scanner 1 is attached to a robot end effector 710, which may include a mounting plate 712 and robot arm 714. The robot may be moved to measure dimensional characteristics of one or more objects under test. In further aspects, the robot end effector is replaced by another type of moving structure. For example, the triangulation scanner 1 may be mounted on a moving portion of a machine tool.

While the invention has been described in detail in connection with only a limited number of aspects, it should be readily understood that the invention is not limited to such disclosed aspects. Rather, the invention can be modified to incorporate any number of variations, alterations, substitutions or equivalent arrangements not heretofore described, but which are commensurate with the spirit and scope of the invention. Additionally, while various aspects of the invention have been described, it is to be understood that aspects of the invention may include only some of the described aspects. Accordingly, the invention is not to be seen as limited by the foregoing description, but is only limited by the scope of the appended claims.

What is claimed is:

1. A computer-implemented method, comprising:
identifying, by a controller, a part that is being transported to a workstation;
capturing, by the controller, a 3D scan of the part using a dynamic machine vision sensor;
validating, by the controller, the part by comparing the 3D scan of the part with a 3D model of the part;
based on a determination that the part is valid, projecting, by the controller, a hologram that includes a sequence of assembly steps associated with the part;
upon completion of the sequence of assembly steps, capturing, by the controller, a 3D scan of an item that is assembled using the part;
validating, by the controller, the item by comparing the 3D scan of the item with a 3D model of the item; and
notifying, by the controller, a validity of the item.

2. The computer-implemented method of claim 1, wherein the part is identified based on one of a machine-readable code associated with the part, and image recognition.

3. The computer-implemented method of claim 1, wherein comparing the 3D scan of the part with a 3D model of the part comprises:
determining an expected measurement of a portion of the part from the 3D model of the part;
determining an actual measurement of the portion of the part from the 3D scan of the part; and
comparing the expected measurement and the actual measurement.

4. The computer-implemented method of claim 1, wherein the hologram that that includes the sequence of assembly steps is a 3D hologram projected to overlap the part.

5. The computer-implemented method of claim 1, wherein the hologram that that includes the sequence of assembly steps is projected onto a designated portion of the workstation.

6. The computer-implemented method of claim 1, wherein the hologram that that includes the sequence of assembly steps further includes the 3D model with one or more highlighted portions that are to be worked upon.

7. The computer-implemented method of claim 6, wherein validating the item comprises displaying the 3D model of the item via an augmented reality device, with one or more portions highlighted, wherein the one or more highlighted portions identify portions of the item that fail to satisfy one or more specifications of the item.

8. The computer-implemented method of claim 1, further comprising, initiating a transportation path to transport the item to a subsequent workstation in response to the item being deemed to be valid.

9. The computer-implemented method of claim 1, further comprising, monitoring, by the controller, personal protective equipment at the workstation, and in response to the personal protective equipment not being equipped, pausing the hologram.

10. A system comprising:
one or more dynamic machine vision sensors;
an augmented reality device; and
a controller coupled with the one or more dynamic machine vision sensors and the augmented reality device, the controller configured to perform a method comprising:
identifying a part that is being transported to a workstation;
capturing a 3D scan of the part using the one or more dynamic machine vision sensors;
validating the part by comparing the 3D scan of the part with a 3D model of the part;
based on a determination that the part is valid, projecting a hologram that includes a sequence of assembly steps associated with the part using the augmented reality device;
upon completion of the sequence of assembly steps, capturing a 3D scan of an item that is assembled using the part;
validating the item by comparing the 3D scan of the item with a 3D model of the item; and
notifying a validity of the item.

11. The system of claim 10, wherein comparing the 3D scan of the part with a 3D model of the part comprises:
determining an expected measurement of a portion of the part from the 3D model of the part;
determining an actual measurement of the portion of the part from the 3D scan of the part; and
comparing the expected measurement and the actual measurement.

12. The system of claim 10, wherein the hologram that that includes the sequence of assembly steps further includes the 3D model with one or more highlighted portions that are to be worked upon.

13. The system of claim 12, wherein validating the item comprises displaying the 3D model of the item via the augmented reality device, with one or more portions highlighted, wherein the one or more highlighted portions identify portions of the item that fail to satisfy one or more specifications of the item.

14. The system of claim 10, wherein the method further comprises, initiating a transportation path to transport the item to a subsequent workstation in response to the item being deemed to be valid.

15. The system of claim 10, wherein the method further comprises, monitoring, by the controller, personal protective equipment at the workstation, and in response to the personal protective equipment not being equipped, pausing the hologram.

16. A computer program product comprising a non-transitory computer readable storage medium having computer executable instructions stored thereupon, the computer executable instructions when executed by one or more processors cause the one or more processors to perform a method comprising:
identifying a part that is being transported to a workstation;
capturing a 3D scan of the part using a dynamic machine vision sensor;
validating the part by comparing the 3D scan of the part with a 3D model of the part;
based on a determination that the part is valid, projecting a hologram that includes a sequence of assembly steps associated with the part;
upon completion of the sequence of assembly steps, capturing a 3D scan of an item that is assembled using the part;
validating the item by comparing the 3D scan of the item with a 3D model of the item; and
notifying a validity of the item.

17. The computer program product of claim 16, wherein the hologram that that includes the sequence of assembly steps further includes the 3D model with one or more highlighted portions that are to be worked upon.

18. The computer program product of claim 17, wherein validating the item comprises displaying the 3D model of the item via an augmented reality device, with one or more portions highlighted, wherein the one or more highlighted portions identify portions of the item that fail to satisfy one or more specifications of the item.

19. The computer program product of claim 16, wherein the method further comprises, initiating a transportation path to transport the item to a subsequent workstation in response to the item being deemed to be valid.

20. The computer program product of claim 16, wherein the method further comprises, monitoring personal protective equipment at the workstation, and in response to the personal protective equipment not being equipped, pausing the hologram.
